(19) United States
(12) Patent Application Publication
(10) Pub. No.: US 2021/0318021 A1
(43) Pub. Date: Oct. 14, 2021

(54) AIR-CONDITIONING AIR OUTLET DEVICE AND AIR CONDITIONER

(71) Applicants: QINGDAO HAIER AIR-CONDITIOING ELECTRONIC CO., LTD, Qingdao, Shandong (CN); HAIER SMART HOME CO., LTD., Qingdao, Shandong (CN)

(72) Inventors: Wenbo LI, Qingdao, Shandong (CN); Qiang SONG, Qingdao, Shandong (CN); Bing WANG, Qingdao, Shandong (CN); Xinbo LIU, Qingdao, Shandong (CN)

(21) Appl. No.: 17/263,927

(22) PCT Filed: Nov. 20, 2019
(86) PCT No.: PCT/CN2019/119652

§ 371 Date: Jan. 28, 2021

(30) Foreign Application Priority Data
Mar. 5, 2019 (CN) 201910162721.5

(51) Int. Cl. F24F 13/06; F24F 13/30; F24F 5/00

(52) U.S. Cl. CPC F24F 13/06; F24F 5/0021; F24F 13/30

(57) ABSTRACT

The present disclosure discloses an air outlet device of an air conditioner and an air conditioner. The air outlet device includes an air storage device and an induced device, wherein the air storage device includes an air storage cavity and an air accelerating structure, and the induced device includes an induced air duct, a mixing port, an air outlet and a heat storage device, wherein an induced air passing through the induced air duct and an air flow accelerated by the air accelerating structure are mixed at the mixing port, the heat storage device is disposed between an outlet of the mixing port and the air outlet, a flow equalization space is formed between the heat storage device and a side wall of the induced air duct, the heat storage device includes a heat exchanger fin provided with at least one communication port and a heat exchange tube.

### CROSS-REFERENCE TO RELATED APPLICATIONS

The application is based upon and claims priority to Chinese Patent Application No. 201910162721.5, filed Mar. 5, 2019, the entire contents of which are incorporated herein by reference.

### TECHNICAL FIELD

The present disclosure relates to the field of air conditioning technologies, and more particularly, to an air outlet device of an air conditioner and an air conditioner.

### BACKGROUND

Air conditioners are equipment that can cool/heat indoors. With the continuous improvement of people's living standards, users have higher and higher requirements for the comfort and health of the air conditioners.

The existing air conditioners have strong air supply and cold air blowing directly, which makes the users feel very uncomfortable, and is easy to cause air conditioning diseases, thereby seriously affecting usage experience and health of the users.

In order to improve the comfort of the air supply of the air conditioner, a breeze radiation panel is used in the prior art. The breeze radiation panel can realize the air outlet without feeling of cold or hot air, thereby improving the comfort of the air conditioner. The previous type of radiation is mainly realized by water and refrigerant. In addition, some manufacturers also use air to achieve heat storage, but the capacity of heat storage is relatively weak.

The existing radiation panels for heat storage mostly use toothed perforated plates, the principle of which is that a high-pressure airflow generated by a duct type air conditioner enters a radiation panel through an air inlet and enters a toothed area. Since there are many small holes in the toothed area, these small holes can form a certain damping, causing the air to form a vortex in the toothed area to heat the aluminum panel and form a certain amount of heat storage, while reducing a speed of the air to form a breeze.

However, air volume in a middle area of the radiation panel is too large, and thus a backflow is formed near the middle area; meanwhile, since an air speed distribution of the radiation panel is uneven, the comfort of the user is reduced.

### SUMMARY

The purpose of the present disclosure is to provide an air outlet device of an air conditioner and an air conditioner, which can improve the air outlet uniformity of the air outlet device of the air conditioner.

According to one aspect of the present disclosure, there is provided an air outlet device of an air conditioner. The air outlet device of the air conditioner includes an air storage device and an induced device, wherein the air storage device includes an air storage cavity and an air accelerating structure communicated with the air storage cavity, and the induced device includes an induced air duct, a mixing port, an air outlet and a heat storage device, wherein an induced air passing through the induced air duct and an air flow accelerated by the air accelerating structure are mixed at the mixing port, the heat storage device is disposed between an outlet of the mixing port and the air outlet, a flow equalization space is formed between the heat storage device and a side wall of the induced air duct, the heat storage device includes a heat exchanger fin and a heat exchange tube, wherein the heat exchange tube contains heat storage material, and the heat exchanger fin is provided with at least one communication port penetrating in a thickness direction of the heat exchanger fin.

Preferably, the heat exchanger fin is a corrugated fin, a slit fin or a multi-louvered fin.

Preferably, the heat exchange tube has a double-layer structure.

Preferably, the heat exchange tube is U-shaped tubes connected in series, and both ends of the heat exchange tube are provided with plugs.

Preferably, the heat exchange tube includes a plurality of heat exchange tubes provided in parallel, each heat exchange tube is a straight tube, and both ends of the heat exchange tube are provided with plugs or one end of at least one of the plurality of heat exchange tubes is provided with a plug.

Preferably, the heat exchange tube is a U-shaped tube, and both ends of the U-shaped tube are respectively provided with plugs or one end of the U-shaped tube is provided with a plug.

Preferably, the at least one communication port includes a plurality of communication ports, and is extended into an elongated shape in a width direction of the heat exchanger fin.

Preferably, the induced air duct is L-shape, and an induced air inlet of the induced air duct and the air outlet are on the same side of the induced device.

Preferably, the heat storage material is paraffin or 65 mol % decanoic acid+35 mol % dodecanoic acid.

According to another aspect of the present disclosure, there is provided an air conditioner. The air conditioner includes an air outlet device of the air conditioner, and the air outlet device of the air conditioner is the above-mentioned air outlet device of the air conditioner.

The air outlet device of the air conditioner of the present disclosure includes the air storage device and the induced device, wherein the air storage device includes the air storage cavity and the air accelerating structure communicated with the air storage cavity, and the induced device includes the induced air duct, the mixing port, the air outlet and the heat storage device, wherein the induced air passing through the induced air duct and the air flow accelerated by the air accelerating structure are mixed at the mixing port, the heat storage device is disposed between the outlet of the mixing port and the air outlet, the flow equalization space is formed between the heat storage device and the side wall of the induced air duct, the heat storage device includes the heat exchanger fin and the heat exchange tube, wherein the heat exchange tube contains heat storage material, and the heat exchanger fin is provided with at least one communication port penetrating in the thickness direction of the heat exchanger fin. According to the above-mentioned air outlet device of the air conditioner, when the air conditioner is blowing, the air passing through the air accelerating structure is accelerated to form a negative pressure to form a suction force on the air at an inlet of the induced air duct, so that air outside the induced air duct can enter along the induced air duct and mix with the accelerated air at the mixing port, so that the mixed air can be induced to the heat storage device. Since the heat storage device includes at least one heat exchanger fin, a gap between the heat exchanger fins is equivalent to a porous medium, a part of the air can be intercepted, and the intercepted air flows back on both sides and passes through the heat storage device at both sides under a pressure. Meanwhile, since the heat exchanger fin is provided with at least one communication port penetrating in the thickness direction of the heat exchanger fin, spaces between each heat exchanger fin can be communicated, the spaces can be communicated in series through the at least one communication port when the air flows through the heat storage device, so that high-pressure air can be equalized into low-pressure air, and the air can be equalized again in the heat storage device, and thus the pressure distribution of the air blown out after passing through the heat storage device is more uniform, and the air speed is more uniform, thereby improving the user experience.

It should be understood that both the foregoing general description and the following detailed description are exemplary and explanatory only and are not intended to limit the present disclosure.

### BRIEF DESCRIPTION OF THE DRAWINGS

The accompanying drawings, which are incorporated in and constitute a part of this description, illustrate embodiments consistent with the present disclosure and, together with the description, serve to explain the principles of the present disclosure.

FIG. 1 is a structural schematic diagram illustrating an air outlet device of an air conditioner according to an embodiment of the present disclosure.

FIG. 2 is a schematic structural diagram illustrating a heat exchanger fin of an air outlet device of an air conditioner according to an embodiment of the present disclosure.

FIG. 3 is a perspective structural diagram illustrating a heat storage device of an air outlet device of an air conditioner according to an embodiment of the present disclosure.

FIG. 4 is a simulation diagram illustrating an air velocity of an air outlet device of an air conditioner according to an embodiment of the present disclosure.

FIG. 5 is a simulation diagram illustrating an air velocity in an induced device of an air outlet device of an air conditioner according to an embodiment of the present disclosure.

FIG. 6 is a diagram illustrating an air speed distribution at an air outlet of an air outlet device of an air conditioner according to an embodiment of the present disclosure.

### DESCRIPTION OF REFERENCE SIGNS

1. air storage device; 2. induced device; 3. air storage cavity; 4. air accelerating structure; 5. induced air duct; 6. mixing port; 7. air outlet; 8. heat storage device; 9. heat exchanger fin; 10. heat exchange tube; 11. communication port.

### DETAILED DESCRIPTION

The following description and accompanying drawings fully illustrate the specific implementation solutions of the present disclosure, so that a person skilled in the art can practice them. Other embodiments may include structural, logical, electrical, procedural and other changes. The embodiments merely represent possible changes. Unless otherwise specified explicitly, the individual component and function are optional and the operation sequence may be changed. Parts and characteristics of some implementation solutions may be included in or replace parts and characteristics of other implementation solutions. The scope of the implementation solutions of the present disclosure includes the whole scope of the claims and all available equivalents of the claims. As used herein, each implementation solution may be independently or generally expressed by “present disclosure”, which is merely for convenience. As a matter of fact, if more than one disclosure is disclosed, it does not mean that the scope of the application is automatically limited to any single disclosure or disclosure concept. As used herein, terms such as “first” and “second” are merely for distinguishing one entity or operation from another entity or operation and do not require or imply any actual relationship or sequence among these entities or operations. Moreover, terms such as “comprise” and “include” or any other variants indicate a non-exclusive inclusion, so that a process, method or device including a series of elements not only include these elements, but also include other elements not explicitly listed, or further include elements inherent to such a process, method or device. Without further restrictions, the element defined by the statement “includes a/an . . . ” does not exclude the existence of other identical elements in the process, method or device that includes the element. As used herein, each embodiment is described progressively, and contents focally described in each embodiment are different from those in other embodiments. The same or similar parts among each of the embodiments may be referred to each other. Regarding a structure, a product and the like disclosed in the embodiments, since they are corresponding to parts disclosed in the embodiments, their description is relatively simple and relevant contents can be referred to the description in the method part.

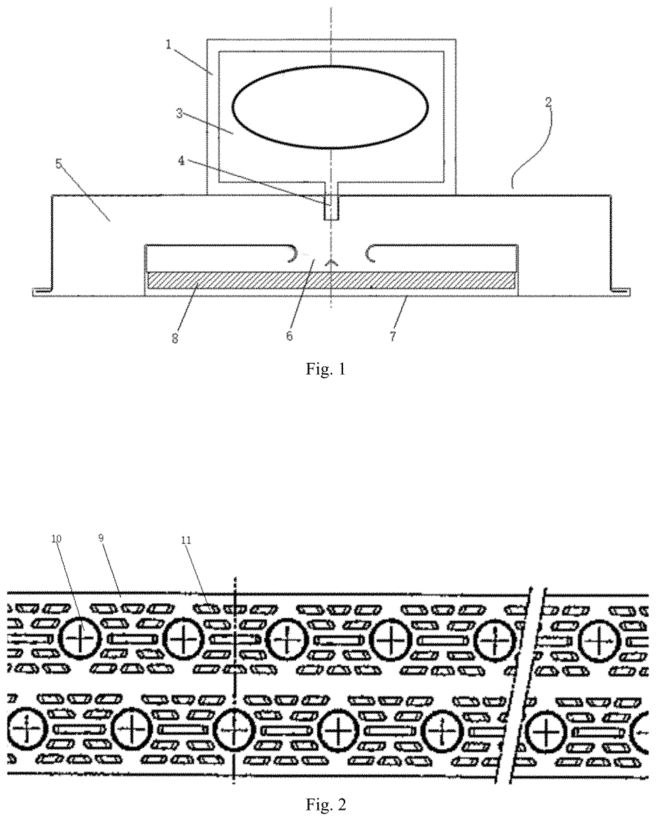

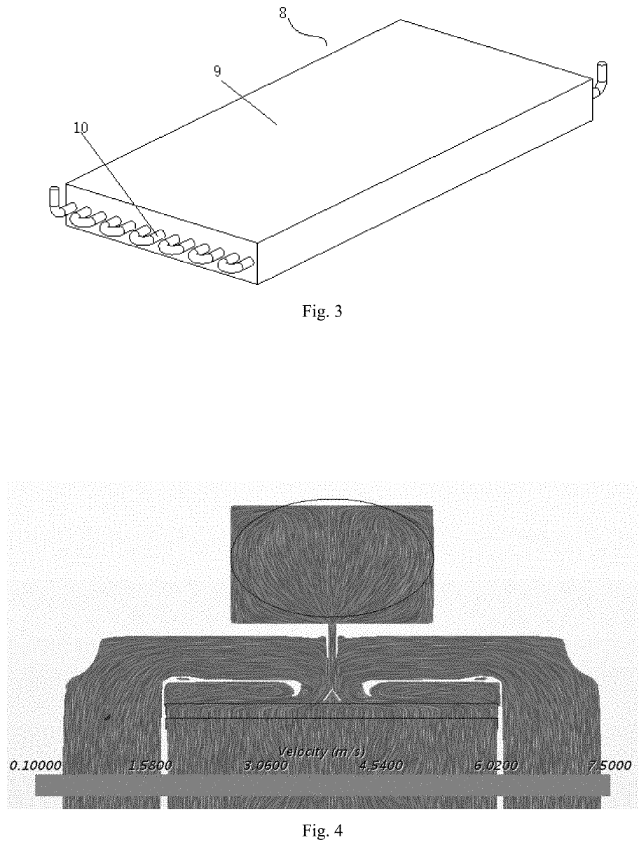

With reference to FIG. 1 to FIG. 6, according to an embodiment of the present disclosure, an air outlet device of an air conditioner includes an air storage device 1 and an induced device 2, wherein the air storage device 1 includes an air storage cavity 3 and an air accelerating structure 4 communicated with the air storage cavity 3, and the induced device 2 includes an induced air duct 5, a mixing port 6, an air outlet 7 and a heat storage device 8. An induced air passing through the induced air duct 5 and an air flow accelerated by the air accelerating structure 4 are mixed at the mixing port 6, the heat storage device 8 is disposed between an outlet of the mixing port 6 and the air outlet 7, a flow equalization space is formed between the heat storage device 8 and a side wall of the induced air duct 5. The heat storage device 8 includes a heat exchanger fin 9 and a heat exchange tube 10, wherein the heat exchange tube 10 contains heat storage material, and the heat exchanger fin 9 is provided with at least one communication port communication port 11 penetrating in a thickness direction of the heat exchanger fin 9.

According to the above-mentioned air outlet device of the air conditioner, when the air conditioner is blowing, the air passing through the air accelerating structure 4 is accelerated to form a negative pressure to form a suction force on the air at an inlet of the induced air duct 5, so that air outside the induced air duct 5 can enter along the induced air duct 5 and mix with the accelerated air at the mixing port 6, so that the mixed air can be induced to the heat storage device 8. Since the heat storage device 8 includes at least one heat exchanger fin 9, the air outlet is more uniform, and the uneven air can be evenly distributed. The heat exchanger fin 9 is equivalent to a porous medium with a certain damping, when a part of the air passes through the porous media, strong air is weakened, and the weakened air speed can be comfortably accepted by a human body, and the other part of the air is intercepted by the heat storage device 8, and the intercepted air flows back on both sides and passes through the heat storage device 8 on both sides under a pressure. Since the heat exchanger fin 9 is provided with at least one communication port 11 penetrating in the thickness direction of the heat exchanger fin 9, spaces between each the heat exchanger fin 9 can be communicated, the spaces can be communicated in series through the at least one communication port 11 when the air flows through the heat storage device 8, so that high-pressure air can be equalized into low-pressure air, and the air can be equalized again in the heat storage device 8, and thus the pressure distribution of the air blown out after passing through the heat storage device 8 is more uniform, and the air speed is more uniform, thereby improving the user experience.

Specifically, the air storage device 1 of the air outlet device of the air conditioner is connected to an air supply outlet of an indoor unit, cold or hot air blown from the indoor unit enters the air storage device 1 first, and then enters the induced device 2 through the air accelerating structure 4 provided between the air storage device 1 and the induced device 2. Since a cross-sectional area of the air accelerating structure 4 is smaller than that of the air supply outlet, the negative pressure is formed in the induced device 2 when the cold or hot air passes through the air accelerating structure 4, so that the air in the indoor unit enters the induced air duct 5 of the induced device 2 through an induced air inlet of the induced device 2. The air entering the induced air duct 5 exchanges heat with the cold or hot air, exchanges heat through the heat storage device 8, and then is discharged back into a room from the air outlet 7 of the induced device 2. With this arrangement, it is possible to prevent the cold or hot air blown from the indoor unit from being directly discharged into the room, that is, the cold or hot air blown from the indoor unit exchanges heat with the air in the indoor unit in the induced device 2 first, and then is discharged back into the room, and thus the comfortable effect of cool but not cold and warm but not hot can be achieved, and the user experience can be improved. The air storage device 1 is an air storage tank. Of course, the air storage device 1 can also be configured as an air cylinder, an air storage box, and the like. The adjustment and change to the specific structure of the air storage device 1 do not deviate from the principle and scope of the present disclosure, and should be limited within the protection scope of the present disclosure.

In addition, it should be noted that the cross-sectional area of the air accelerating structure 4 refers to an area of a cross section where the cold or hot air passes through the air accelerating structure 4, and an area of the air supply outlet refers to an area of a cross section where the cold or hot air passes through the air supply outlet. Since a volume of the cold or hot air passing through the air accelerating structure 4 is the same as that passing through air supply outlet in the same time, and the cross-sectional area of the air accelerating structure 4 is smaller than that of the air supply outlet, a speed of the cold or hot air passing through the air accelerating structure 4 is greater than that passing through the air supply outlet, and thus the air is accelerated and the negative pressure is formed in the induced device 2 to induce the air in the indoor unit into the induced device 2.

In the present embodiment, the air accelerating structure 4 is an accelerating port communicating the induced device 2 and the air storage device 1, the accelerating port can be directly provided on a side wall of the induced device 2, or can be directly provided on a side wall of the air storage device 1. Preferably, the accelerating port is provided with an air guide tube extending towards the mixing port 6, so that an air supply distance of the accelerating port can be increased, and a better inducing effect can be achieved. An inner diameter of the air guide tube should be the same as a diameter of the accelerating port.

Preferably, the heat exchanger fin 9 is a corrugated fin, a slit fin or a multi-louvered fin.

Preferably, the heat exchange tube 10 has a double-layer structure, and thus a larger heat exchange area can be formed. In addition, more heat storage materials are stored in the heat storage device 8, and thus the temperature adjustment capability of the heat storage device 8 can be improved. The heat exchange tube 10 is, for example, a copper tube.

In one embodiment, the heat exchange tube 10 is U-shaped tubes connected in series, and both ends of the heat exchange tube 10 are provided with plugs. Two adjacent U-shaped tubes are packaged by a U-shaped elbow, and thus the sealing performance of the heat storage material can be ensured. Since the heat exchange tube 10 is filled with the heat storage material, and the heat storage material only needs to be kept in the heat storage device 8 without circulating in other devices, it is only necessary to plug the both ends of the heat exchange tube with the plugs to form a seal.

In another embodiment, the heat exchange tube 10 includes a plurality of heat exchange tubes 10 provided in parallel, each heat exchange tube 10 is a straight tube, and both ends of the heat exchange tube 10 are provided with plugs or one end of at least one of the plurality of heat exchange tubes 10 is provided with a plug. In this embodiment, the plurality of heat exchange tubes 10 are not communicated with each other, and each heat exchange tube 10 is filled with the heat storage material.

In another embodiment, the heat exchange tube 10 is a U-shaped tube, and both ends of the U-shaped tube are respectively provided with plugs or one end of the U-shaped tube is provided with a plug. One end of the U-shaped tube can be sealed, and the other end can be sealed by the plug. The both ends of the U-shaped tube can also be sealed by the U-shaped elbow.

Preferably, the at least one communication port 11 includes a plurality of communication ports 11, and is extended into an elongated shape in a width direction of the heat exchanger fin 9. By providing a plurality of elongated communication ports 11, the air intercommunication in the heat storage device can be realized more conveniently, and thus the uniformity of the air pressure distribution and the air outlet speed can be ensured.

In this embodiment, the induced air duct 5 is L-shape, and an induced air inlet of the induced air duct 5 and the air outlet 7 are on the same side of the induced device 2.

The heat storage material is paraffin or 65 mol % decanoic acid+35 mol % dodecanoic acid, and the like. The heat storage material has a large specific heat capacity, and thus it has a strong heat storage capacity. The phase change heat storage material in constant temperature defrosting multi-line can be used, or paraffin which is easier to handle can also be used.

The material property of paraffin or 65 mol % decanoic acid+35 mol % dodecanoic acid is shown in the following table:

| | | 65 mol % decanoic | |
|---|---|---|---|
| | | acid + 35 mol % | |
| phase change material | | dodecanoic acid | paraffin |
| phase change temperature | | 18° C. | 28° C. |
| phase change latent heat | | 140.8 kJ/kg | 244 kJ/kg |
| heat conductivity | liquid | 0.139 W/(mk) | 0.148 W/(mk) |
| coefficient | solid | 0.143 W/(mk) | 0.15 W/(mk) |
| density | liquid | 0.895 kg/m³ | 0.774 kg/m³ |
| | solid | 0.900 kg/m³ | 0.814 kg/m³ |
| specific heat | liquid | 2.24 kJ/(kgK) | 2.0 kJ/(kgK) |
| | solid | 1.97 kJ/(kgK) | |

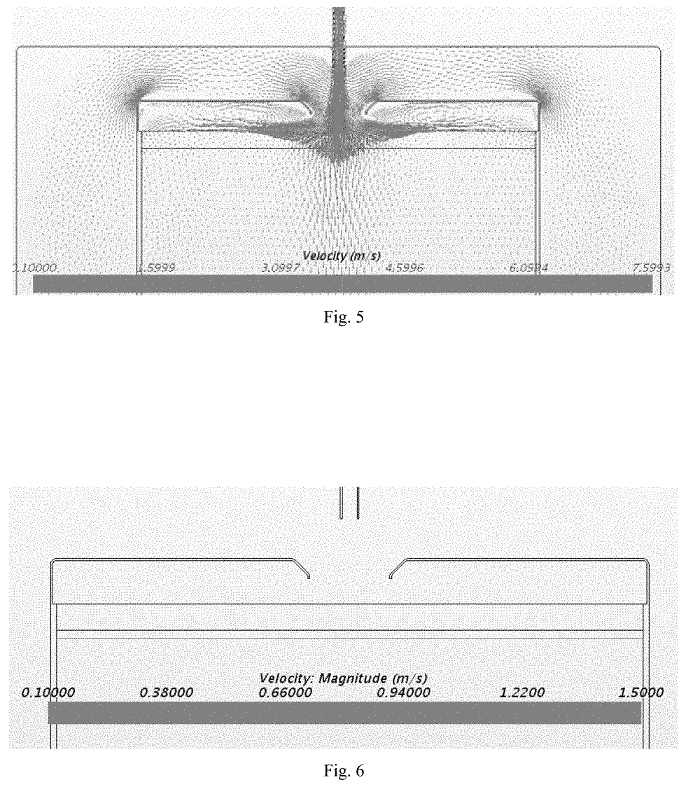

As shown in FIG. 4 and FIG. 5, the air first enters the air storage box under the action of the duct type air conditioner, and the like, after the air storage box is filled, the air enters an accelerating zone. Since the cross section of the outlet of the accelerating port suddenly becomes smaller, the air speed increases sharply, i.e., the air speed increases from no more than 6 m/s to 7.5 m/s at the accelerating port of the air storage box. Then, the air enters the mixing port to form the negative pressure, the air in the indoor unit enters from the induced air inlet under the action of the negative pressure, reaches the mixing port 6 along the induced air duct 5, and mixes with the air blown from the accelerating port. Then, the mixed air reaches the heat storage device 8, under the shielding effect of the heat storage device, a part of the air is blown out after being decelerated and depressurized by the middle part of the heat storage device 8, and the other part of the air enters an air equalizing cavity formed between the induced air duct 5 and the heat storage device 8 from both sides, and is decelerated and depressurized by the parts on both sides of the heat storage device 8 under the air pressure in the air equalizing cavity, and then is blown out by the heat storage device 8. Since the flat plane of the heat exchanger fin 9 has a rectifying effect, the flow velocity distribution of the air blown out by the heat storage device 8 is more uniform, and no vortex and backflow are generated, thereby effectively improving the air outlet efficiency.

It can be seen from FIG. 4 to FIG. 6 that the overall air speed of the air blown out after decompression, deceleration and rectification by the heat storage device 8 is reduced to below 1.2 m/s, and the air speed of the middle part with the highest air speed is also reduced to about 1 m/s, and the air speed of other parts except the middle part corresponding to the mixing port 6 does not exceed 0.5 m/s, and thus the breeze blowing is basically realized, and the user experience is better.

According to an embodiment of the present disclosure, an air conditioner includes an air outlet device of the air conditioner, which is the above-mentioned air outlet device of the air conditioner.

It should be understood that, the present disclosure is not limited to the flowchart and structures described above and shown in the accompanying drawings, and various modifications and changes may be made without departing from the scope. The scope of the present disclosure is limited only by the appended claims.

1. An air outlet device of an air conditioner, comprising an air storage device and an induced device, wherein the air storage device comprises an air storage cavity and an air accelerating structure communicated with the air storage cavity, and the induced device comprises an induced air duct, a mixing port, an air outlet and a heat storage device, wherein an induced air passing through the induced air duct and an air flow accelerated by the air accelerating structure are mixed at the mixing port, the heat storage device is disposed between an outlet of the mixing port and the air outlet, a flow equalization space is formed between the heat storage device and a side wall of the induced air duct, the heat storage device comprises a heat exchanger fin and a heat exchange tube, wherein the heat exchange tube contains heat storage material, and the heat exchanger fin is provided with at least one communication port penetrating in a thickness direction of the heat exchanger fin.

2. The air outlet device of the air conditioner according to claim 1, wherein the heat exchanger fin is a corrugated fin, a slit fin or a multi-louvered fin.

3. The air outlet device of the air conditioner according to claim 1, wherein the heat exchange tube has a double-layer structure.

4. The air outlet device of the air conditioner according to claim 1, wherein the heat exchange tube is U-shaped tubes connected in series, and both ends of the heat exchange tube are provided with plugs.

5. The air outlet device of the air conditioner according to claim 1, wherein the heat exchange tube comprises a plurality of heat exchange tubes provided in parallel, each heat exchange tube is a straight tube, and both ends of the heat exchange tube are provided with plugs or one end of at least one of the plurality of heat exchange tubes is provided with a plug.

6. The air outlet device of the air conditioner according to claim 1, wherein the heat exchange tube is a U-shaped tube, and both ends of the U-shaped tube are respectively provided with plugs or one end of the U-shaped tube is provided with a plug.

7. The air outlet device of the air conditioner according to claim 1, wherein the at least one communication port comprises a plurality of communication ports, and is extended into an elongated shape in a width direction of the heat exchanger fin.

8. The air outlet device of the air conditioner according to claim 1, wherein the induced air duct is L-shape, and an induced air inlet of the induced air duct and the air outlet are on the same side of the induced device.

9. The air outlet device of the air conditioner according to claim 1, wherein the heat storage material is paraffin or 65 mol % decanoic acid+35 mol % dodecanoic acid.

10. An air conditioner, comprising an air outlet device of the air conditioner, wherein the air outlet device of the air conditioner is the air outlet device of the air conditioner according to claim 1.

11. An air conditioner, comprising an air outlet device of the air conditioner, wherein the air outlet device of the air conditioner is the air outlet device of the air conditioner according to claim 2.

12. An air conditioner, comprising an air outlet device of the air conditioner, wherein the air outlet device of the air conditioner is the air outlet device of the air conditioner according to claim 3.

13. An air conditioner, comprising an air outlet device of the air conditioner, wherein the air outlet device of the air conditioner is the air outlet device of the air conditioner according to claim 4.

14. An air conditioner, comprising an air outlet device of the air conditioner, wherein the air outlet device of the air conditioner is the air outlet device of the air conditioner according to claim 5.

15. An air conditioner, comprising an air outlet device of the air conditioner, wherein the air outlet device of the air conditioner is the air outlet device of the air conditioner according to claim 6.

16. An air conditioner, comprising an air outlet device of the air conditioner, wherein the air outlet device of the air conditioner is the air outlet device of the air conditioner according to claim 7.

17. An air conditioner, comprising an air outlet device of the air conditioner, wherein the air outlet device of the air conditioner is the air outlet device of the air conditioner according to claim 8.

18. An air conditioner, comprising an air outlet device of the air conditioner, wherein the air outlet device of the air conditioner is the air outlet device of the air conditioner according to claim 9.
